(19) United States
(12) Patent Application Publication
(10) Pub. No.: US 2015/0177720 A1
(43) Pub. Date: Jun. 25, 2015

(54) BUILDING AUTOMATION SYSTEM AND METHOD

(71) Applicant: Anuva Automation, Inc., Melbourne, FL (US)

(72) Inventors: Michael Anderson, Orlando, FL (US); Bert Culpepper, Orlando, FL (US); Matthew Curtin, Rye, NH (US); David Fonseca, Palmetto Bay, FL (US)

(73) Assignee: ANUVA AUTOMATION, INC., Melbourne, FL (US)

(21) Appl. No.: 14/495,873

(22) Filed: Sep. 24, 2014

Related U.S. Application Data
(60) Provisional application No. 61/881,665, filed on Sep. 24, 2013.

(51) Int. Cl. G05B 15/02; H04L 12/28

(52) U.S. Cl. CPC G05B 15/02; H04L 12/2803

(57) ABSTRACT

Certain embodiments of the present invention are directed to an improved building automation system, a system and method for configuring a building automation system, and a system and method for storing and recalling at will physical hardware settings for a building automation system that solves the shortcomings of the known art. Embodiments of the present invention provide control of lighting, audio distribution, and climate functions within a home or building. Elements for audio distribution and control are connected using a wired or wireless IP network. Lighting and climate controls are also connected using a wired or wireless network.

### CROSS-REFERENCE TO RELATED APPLICATIONS

This application claims the benefit of U.S. Provisional Patent Application No. 61/881,665, filed on Sep. 24, 2013, which is incorporated herein by reference.

### STATEMENT REGARDING FEDERALLY SPONSORED RESEARCH OR DEVELOPMENT

Not applicable.

### FIELD OF THE INVENTION

This invention relates generally to the field of building automation, and, more particularly, to an improved system and method for configuring a building automation system, and storing and recalling at will physical hardware settings for a building automation system.

### BACKGROUND

Current building automation systems are complicated, expensive, and require specially trained personnel to install and configure the system for the end-user. Some systems can only control discrete components, such as lighting, climate, or music components. Other systems, while being able to control multiple types of components, require expensive centralized control units. These centralized control units are often matrix systems, able to control a specified number of zones. Due to their fixed-zone capabilities, an installation must conform to the number of zones supported, a multiple of the number of zones supported, or purchase more zone support than required and be left with unused zones.

The current state of the art in building automation systems typically requires professional installation and configuration. This makes it difficult or impossible for the end-user, or homeowner, to install their own system or configure or modify an installed system.

It would be desirable to have a building automation system and method that is secure, easy to install and configure, and scalable to the needs and budget of the end-user.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

The Building Automation System (BAS) disclosed herein is the perfect middle ground between high-end automation systems and those available to the do-it-yourself (DIY) market. Embodiments of this BAS offer the sophisticated features of high-end solutions, but without the complexity that comes along with the implementation of those solutions.

Certain embodiments of the present invention are directed to an improved building automation system, a system and method for configuring a building automation system, and a system and method for storing and recalling at will physical hardware settings for a building automation system that solves the shortcomings of the known art.

Embodiments of the present invention provide control of lighting, audio distribution, and climate functions within a home or building. Elements for audio distribution and control as well as lighting and climate controls are connected using a wired or wireless IP network.

The BAS disclosed herein is a scalable automation solution as opposed to most others currently known in the art. The decentralized architecture of this BAS means that there is neither large upfront investment required nor bulky equipment requiring rack space. The cost per room is virtually flat, so there is no penalty for going big or small. Plus, the system and the individual elements within it connect wired or wirelessly, so it's easy to add more rooms and elements after the initial installation. Consumers can try the product with minimal investment and then add more functionality and elements over time, which is a needed improvement over the current state of the art for building automation systems.

Glossary:

App—application

BAS—Building Automation System

BAS Network—a wired and/or wireless network provided by the Master Controller separate from the user's network whereby communications among the system elements, server and one or more clients, use TCP and UDP sockets over an IP network

Bluetooth—a standard for the short-range wireless interconnection of cellular phones, computers, and other electronic devices

Elements—client devices that are operably connected to the BAS as nodes on the BAS network and are able to send and receive control events.

Experiences—a preconfigured collection of Moods as applied to one or Elements that is saved by the system for later recall.

HVAC—heating, ventilation, and air conditioning system

IP—Internet Protocol

LAN—Local Area Network

Moods—a pre-configured collection of settings as applied to one or more Elements that is saved by the system for later recall.

MP3—digital audio file, digital audio format

Smartphone—a wireless communication device that runs computer applications.

Tablet—a wireless, touchscreen-enabled computing device that runs computer applications.

TCP—TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent.

UDP—UDP (User Datagram Protocol) is a communications protocol that offers a limited amount of service when messages are exchanged between computers in a network that uses the Internet Protocol (IP). UDP is an alternative to the Transmission Control Protocol (TCP) and, together with IP, is sometimes referred to as UDP/IP.

UI—User Interface

UPnP—Universal Plug and Play is a set of networking protocols that permits networked devices, such as personal computers, printers, Internet gateways, Wi-Fi access points and mobile devices to seamlessly discover each other's presence on the network and establish functional network services for data sharing

WAN—Wide Area Network

WPS—Wi-Fi Protected Setup (WPS) is a network security standard that attempts to allow users to easily secure a wireless home network but could fall to brute-force attacks if one or more of the network's access points do not guard against the attack.

### BRIEF DESCRIPTION OF THE DRAWINGS

These and other features, aspects and advantages of embodiments of the present invention will become better understood with regard to the following description, appended claims, and accompanying drawings where:

FIG. 1 shows a diagram of an exemplary simplified depiction of a building automation system in which embodiments of the present invention can be implemented;

FIG. 2 shows a diagram of an exemplary simplified depiction of network communications in a building automation system in which embodiments of the present invention can be implemented;

FIG. 3 shows a diagram of an exemplary simplified depiction of network communications via a remote access server in a building automation system in which embodiments of the present invention can be implemented;

FIG. 4 shows a diagram of an exemplary simplified depiction of the message exchange for UI applications on the MCs WAN communicating with BAS elements inside the BAS network;

FIG. 5 shows views of a Master Coordinator according to an embodiment of the present invention;

FIG. 6 shows a simplified pictorial illustration of the hardware requirements for implementing some or all of the components of the Building Automation System, in which the present disclosure may be implemented;

FIG. 7 shows views of a Touchpad Lighting Control according to an embodiment of the present invention;

FIG. 8 shows views of an Audio Zone Unit according to an embodiment of the present invention;

FIGS. 9 through 22 show user interface screens for the BAS Application Software according to an embodiment of the present invention.

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

While embodiments of the invention are directed to installations of automation systems in buildings, that is, fixed structures such as homes, apartments, or office buildings, it is contemplated to be within the scope of this disclosure that the same embodiments may be directed to installations in other environments including, but not limited to, airplanes, boats, and recreational vehicles.

We discuss and disclose herein an integrated system comprised of various hardware and software components that utilize methods of configuration and control in order to perform various building automation functions.

Embodiments of the BAS empower the end-user consumers by allowing them to set their own home automation pre-set configurations. These pre-set configurations, and combinations of pre-set configurations, are referred to here as scenes or, more particularly, Moods and Experiences. This allows consumers to make small adjustments to their system whenever they desire without needing to call a professional. Though more commonly seen with DIY solutions, this type of on-demand customization is what an end-user consumer should expect from a high-end automation system. Still, unlike clunky DIY products, the BAS disclosed herein is designed to integrate seamlessly into the customer's home or building.

The approach disclosed here puts the power of automation in the customer's hands. With the BAS application software, customers can simply walk into a room, set all the elements to the desired levels and tap a user interface button to “Capture Mood”. Instantly, every nuance of those settings is saved and can be recalled at anytime. Users can schedule Moods to start at certain times of the day or sync with events such as sunrise or sunset. Once a user captures a few Moods for their various rooms, they can group a collection of Moods to create an Experience for the whole house. The key difference over the current state of the art is that with this BAS the customer can create, edit and activate their Moods and Experiences without having to bring the integrator back to the home.

The BAS application software automatically finds all of the BAS elements within the home. Then the user gives each element a name and assigns it to a room. All this can be done in less than 60 seconds for each BAS element.

Embodiments of the BAS comprise a central node that stores configuration and control information; individual nodes that perform control functions such as, but not limited to, lighting, electrical, audio, and HVAC appliances; and nodes with a user interface for using the system configuration and control information; wherein all the nodes are connected via a data network.

A typical embodiment of the BAS will include one Server on the data network that maintains a database representing the system configuration, where the system configuration consists of an inventory of the system control devices for performing control functions, control profiles for all system control devices, and control profiles that combine control profiles. A typical embodiment of the BAS may also contain one or more system control devices that are Clients on the data network. The Clients typically provide a control interface for interfacing and controlling appliances such as, but not limited to, lighting, audio, HVAC, and user interfaces. The data network may be an Internet Protocol (IP) network with nodes connected using wired interfaces, wireless interfaces, or a combination of wired and wireless interfaces commonly found in commercial computing devices. The system may also comprise a BAS communications protocol that may be utilized in order to allow the Server and one or more Clients to interact in order to realize the control features of the BAS by the user.

Embodiments of the BAS may provide control of lighting, audio distribution, and climate functions within a building or other space. Components for audio distribution and control may be connected using wired, wireless, or a combination of wired and wireless IP network. Lightning and climate controls may also be connected using a wired or wireless IP network.

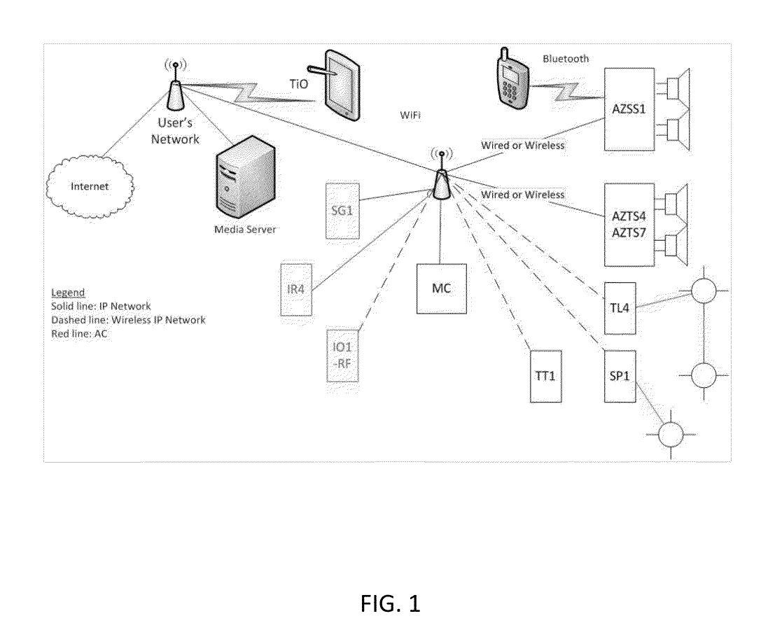

A diagram of an exemplary simplified depiction of a building automation system in which embodiments of the present invention can be implemented is shown in FIG. 1.

A typical system, as shown in FIG. 1, may comprise various nodes operably connected on the BAS network wherein the various nodes may include one or more audio zones, lighting controls, or climate controls. A single Master Coordinator (MC) acts as the central node on the BAS network. User devices such as personal computers, tablet-computing devices, smartphones, Bluetooth enabled devices, and media servers may also be nodes on the BAS network or may connect operably to the user's network and access the BAS network through the MC.

A typical installation may include a wireless network (provided by the MC), separate from the user's network, for connectivity of the audio zone clients when connected to the BAS via their wireless network interface. This networking configuration serves to isolate the BAS network from the user's network thereby preventing network traffic on the user's network from impeding the performance of the BAS, particularly the streaming audio part of the system.

Although it is contemplated that embodiments of this Building Automation System may comprise and support many different components, a description of exemplary embodiments of BAS components follows.

BAS Application Software

BAS Application Software may be provided to run on user devices. It provides the user interface to the operation of the system. It also provides the user interface for system setup. All functions for system operation and setup are supported via the application. The application software is the primary component in the system for operation and setup. The computing environment disclosed for running of the BAS Application Software is provided in this specification, below.

When the user device and the Master Coordinator are operably connected to the user's network, the application software allows the end user to perform system setup functions and to operate the system. The application software also allows for advanced setup and operation of the system. The BAS Application Software is able to connect to the components on the private BAS Network through the Master Coordinator.

Embodiments of the BAS Application Software operably connect to the BAS network through a remote connection via the Internet.

Embodiments of the BAS Application Software may run on embodiments of the audio zone elements that also comprise touch screens.

Master Coordinator

FIG. 5 shows views of a Master Coordinator according to an embodiment of the present invention.

The MC is the central repository of the system setup data. User interface applications retrieve and store the setup data as needed. Control logic for any 3rd-party control devices is also provided by the MC.

The MC hardware platform comprises a router and wireless access point as is currently known in the art. Other embodiments of the MC are contemplated to run on any Linux-based device supporting standard IP networking.

The MC hardware further comprises a computer system, as described below, configured to execute a BAS protocol server process that allows system components to configure and retrieve the system's configuration as well as to handle communications with the nodes on the IP network connected wireless or wired.

Inclusion of new devices on the wireless network may be handled using WPS.

Touchpad Lighting Control

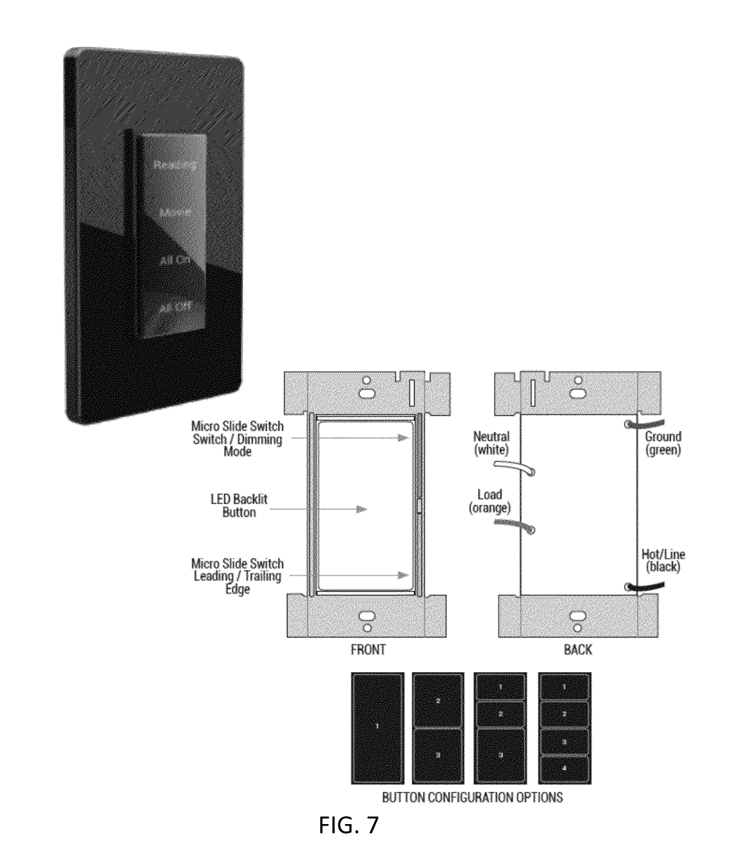

FIG. 7 shows views of a Touchpad Lighting Control according to an embodiment of the present invention.

The Touchpad Lighting Control provides electrical load control for a directly connected load. It can be configured as a 1, 2, or 4 button switch with the first button used for local load control. The remaining buttons can be configured to activate Experiences and/or Moods.

The Touchpad Lighting Control comprises a micro-controller and a wireless IP network interface. Electrical load control is supported via GPIO signals (which may control relays). The Touchpad Lighting Control further comprises embedded software.

Wall Plug Outlet

The Wall Plug Outlet comprises a system controllable wall plug electrical outlet. It can be used for control of electrical devices where no local user interface is required.

The Wall Plug Outlet comprises a micro-controller, a wireless IP network interface, and embedded software.

Thermostat

The Thermostat comprises a micro-controller, a wireless IP network interface, a touch screen, and embedded software.

Audio Zone Unit

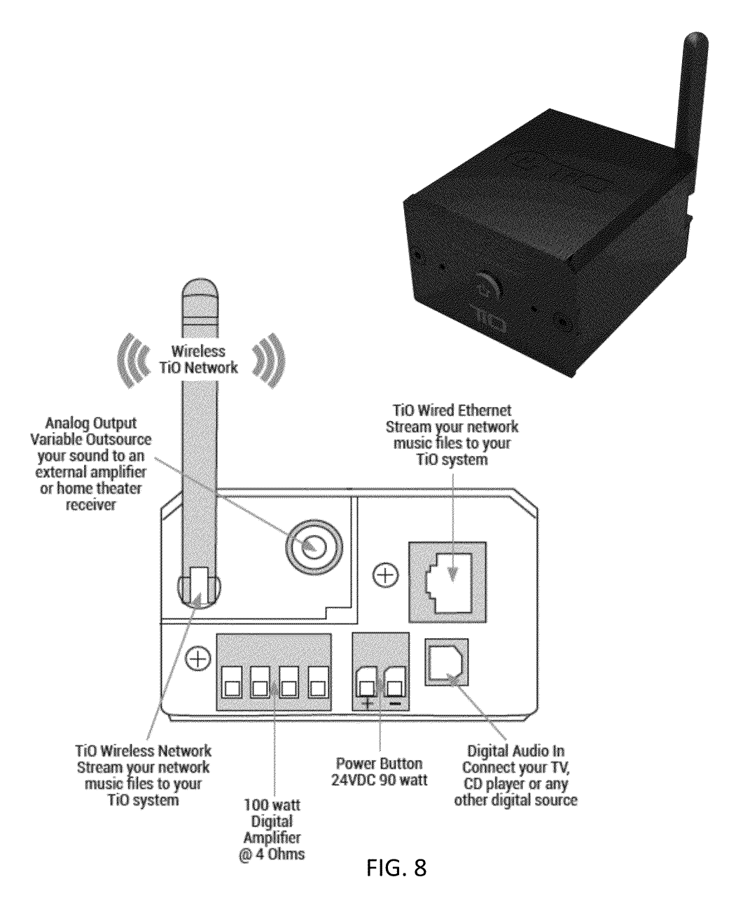

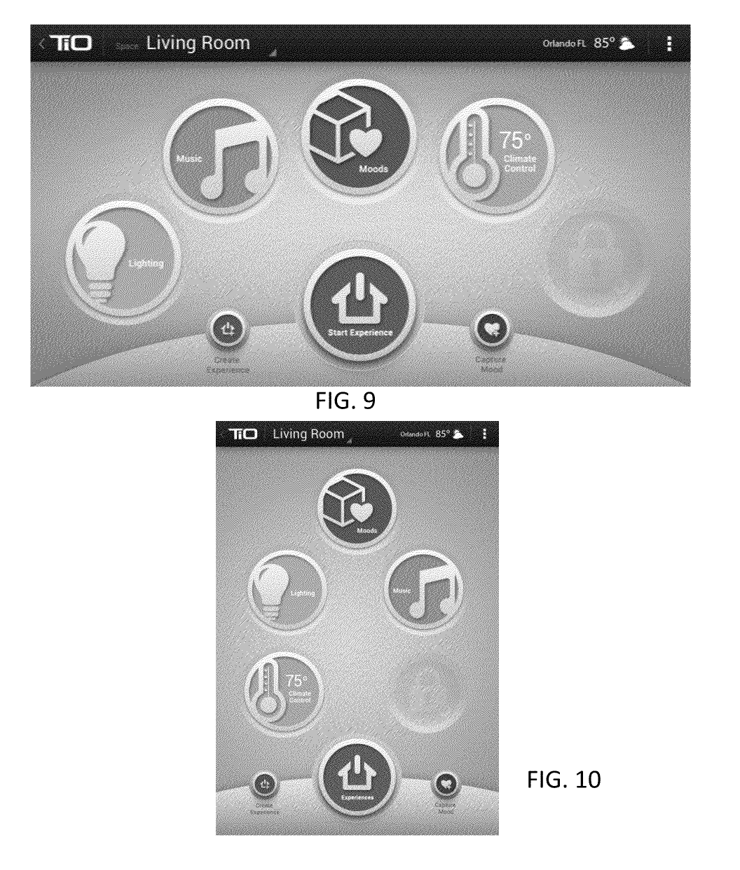

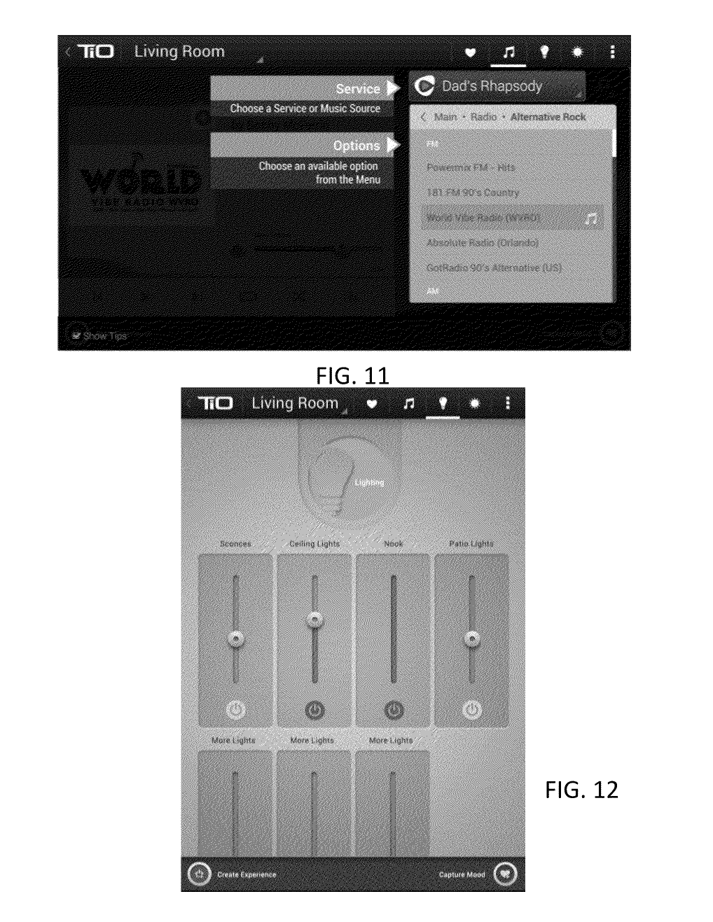

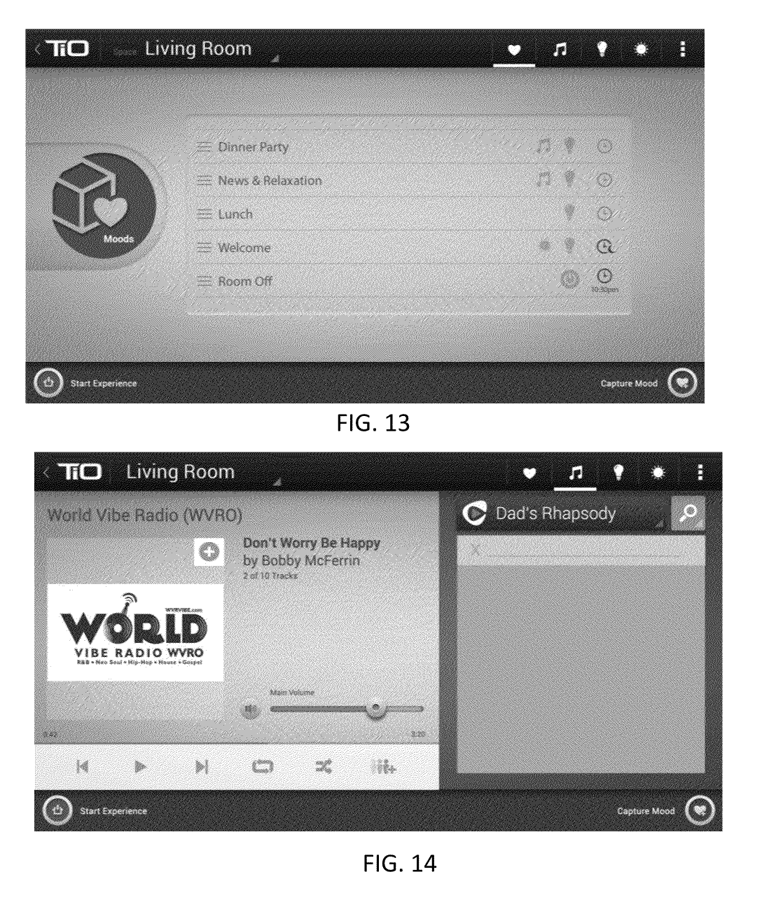

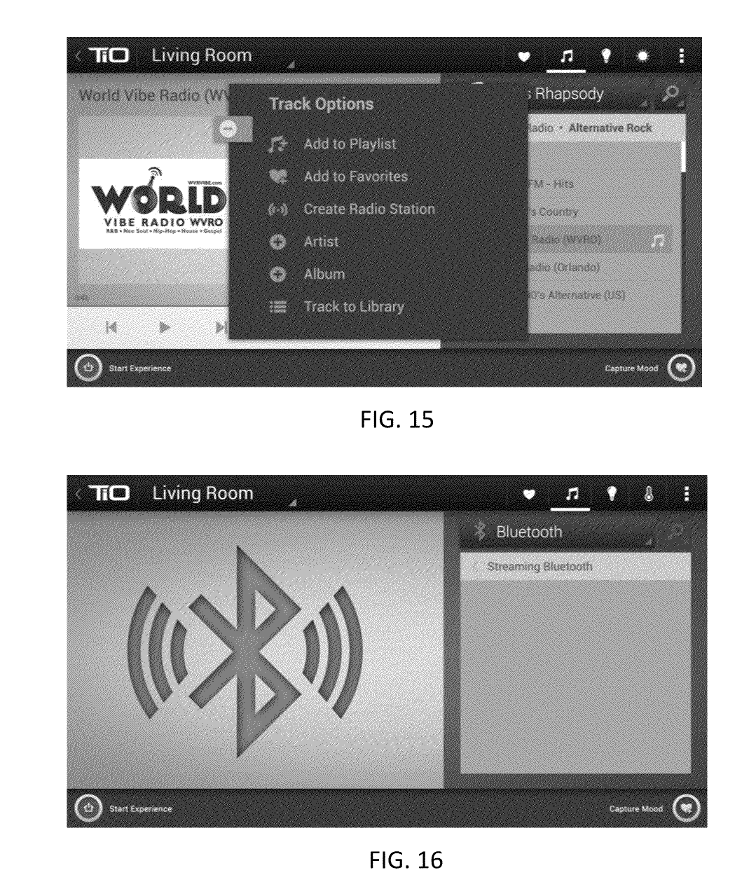

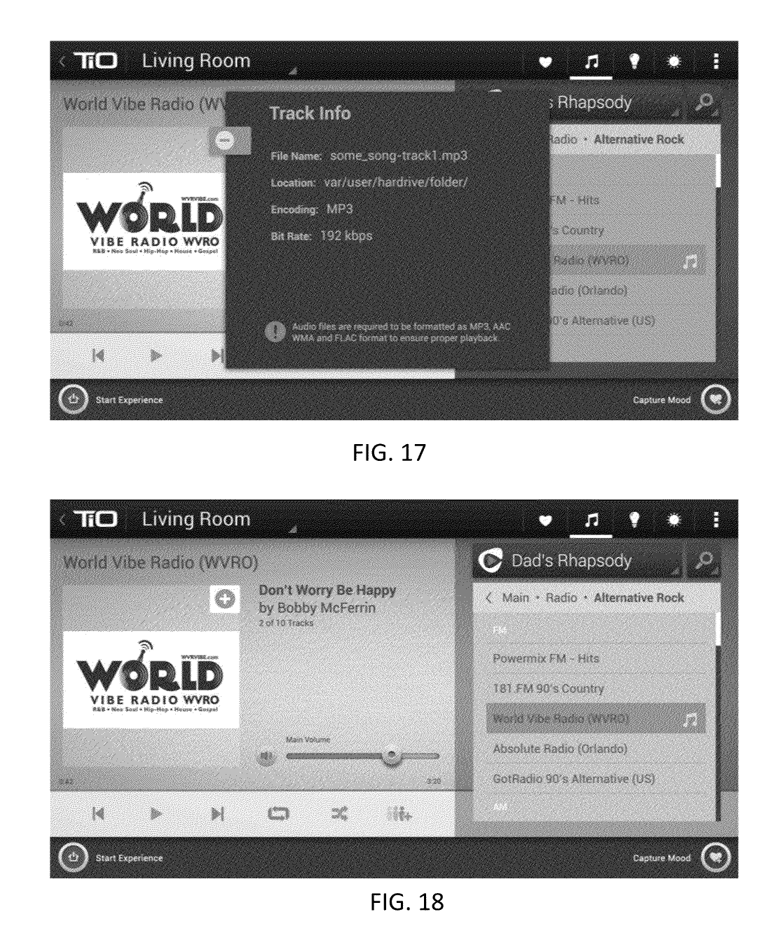

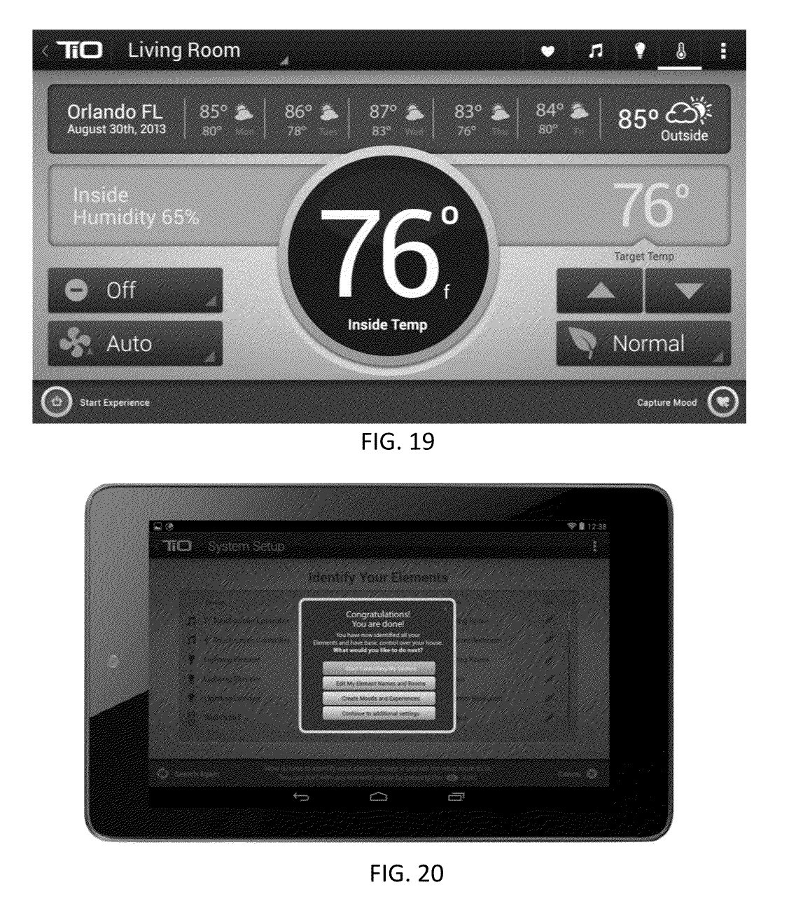

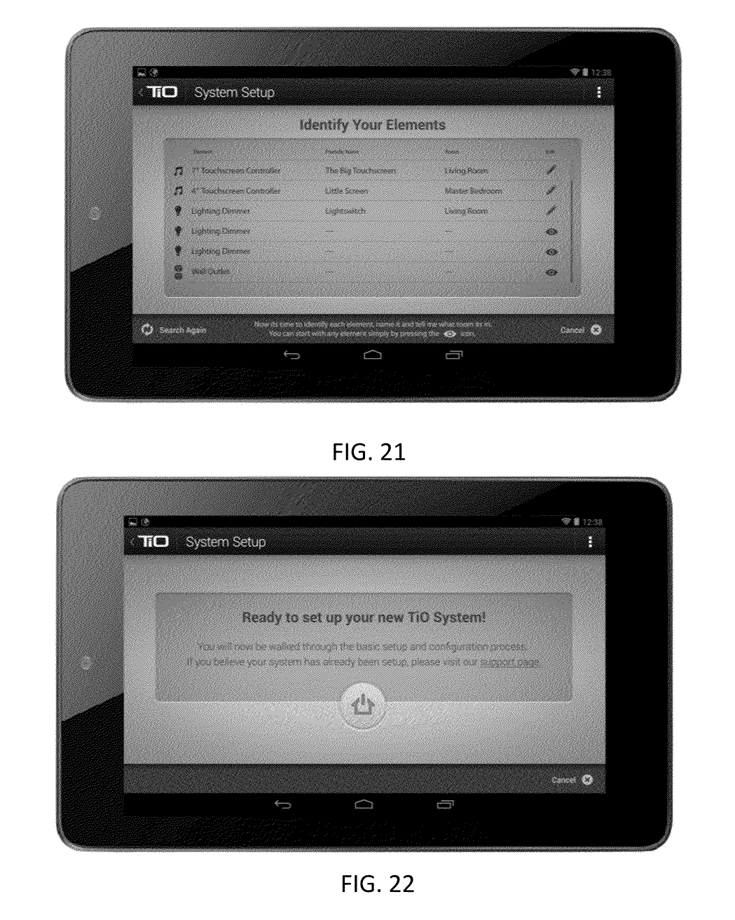

FIG. 8 shows views of an Audio Zone Unit according to an embodiment of the present invention.

The Audio Zone unit provides a local audio zone and is an in-wall amplified streaming audio player.

An embodiment of the Audio Zone unit comprises a micro-controller, embedded software, a wireless IP network interface, an audio amplifier, audio input and output interfaces, audio streaming circuitry as is known in the art, an amplifier, Ethernet network connection, Digital line level audio input, and digital line level audio output.

Further embodiments of the Audio Zone Unit may further comprise a touch screen for the presentation of a user interface so that the user may interact with an embodiment of the BAS Application Software.

Embodiments of the Audio Zone Unit comprise a housing configured to fit in a standard 1-gang box. This embodiment enables the user to replace existing 1-gang volume controls with Audio Zone Units.

IP Network Considerations

The IP network used for system communications includes wired and wireless connections. The BAS IP-based devices are connected to the private network provided by the MC. The MC's WAN port is connected to the user's network for Internet access, and for BAS access to the user's media sources via the UPnP protocol.

BAS Communications Protocol

The system communications protocol uses a client-server network model. The MC performs the server functions and all other system components perform client functions. The communications protocol is called the BAS protocol, and is described in the BAS Protocol Specification document. A description of its overall operation follows.

The MC creates a TCP/IP socket on a port, and accepts connections from clients on this port. Clients create a connection to the MC and use the connection to exchange setup and configuration data with the MC. All clients maintain this connection to the MC to send and receive setup and configuration data while the system is operating.

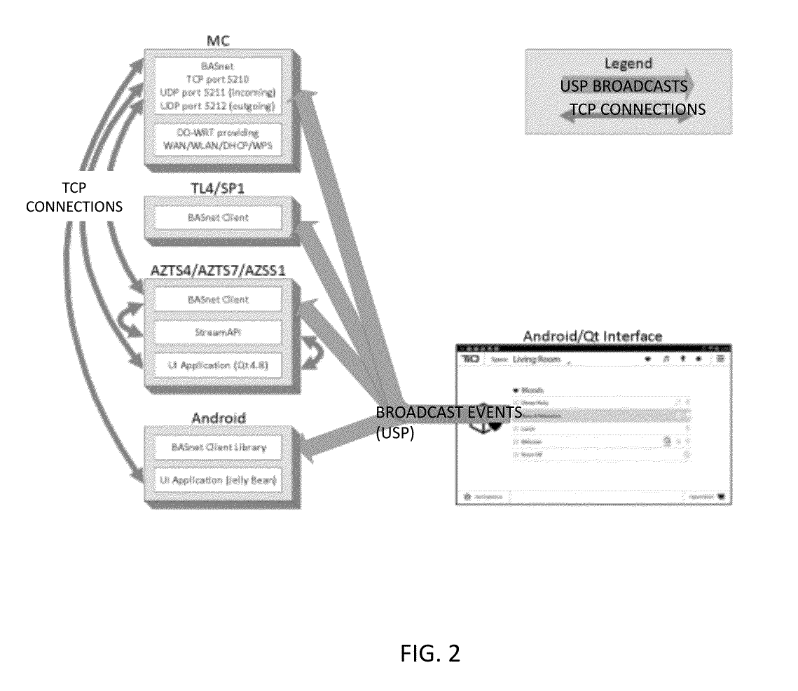

The MC also creates a TCP/UDP socket on a port that it uses to receive broadcast packets on. The MC uses this connection to allow clients to discover the MC's IP address, and to record events broadcast on the IP network. Each system component sends control events to the network's broadcast address and a port. Clients listen on this port to receive control events. FIG. 2 shows a diagram of an exemplary simplified depiction of network communications in a building automation system in which embodiments of the present invention can be implemented.

Communications among the system elements use TCP and UDP sockets over a wireless IP network. This is known as the BAS Network. The BAS network consists of a single server and multiple clients. The Master Coordinator (MC) performs the server function, all other elements act as clients. Clients must establish an association with the server before data communications can occur. Once the association is established, the server and clients can send data to each other.

Preferred embodiments of the MC comprise two network interfaces for connecting to two separate networks:

1) A wired WAN network interface connects the MC to the user's home/office network; and

2) A LAN network supporting both wired and wireless connections that all audio, lighting, and climate client elements use to connect to the MC.

TCP is used between the MC and all other system elements for exchanging system configuration data. Operational events, and some Element to Element communications, use UDP to send and receive broadcast packets on the BAS network. The port for TCP communications with the MC is 5210. The port for UDP broadcast packets is 5211.

The server supports discovery of its IP address by responding to a known message broadcast from a client. It responds to the client with a message that contains the server's IP address. This message exchange is done using UPD. The server has a discovery process that listens on port 5211, it will send its response on port 5212. Clients should open a socket on port 5212 and listen for the response before sending the discovery message. The payload of the server's response packet contains the server's IP Address. The client can use the server IP address to open a TCP connection to the server for all subsequent communications with the server.

Once the IP address of the server is known, clients can establish an association with the server. This association must be established before any other communications can occur. This behavior allows the server to control which clients participate in the system. This functionality is also used to separate BAS system networks when multiple networks may be close to each other and consequently wireless networks overlap in range. This specification defines a message that can be sent to the server's discovery process which will allow enabling and disabling new client associations. This feature will allow the BAS Application Software to control when the MC will accept new devices.

Communication between the server (MC) and User Interface (UI) clients (the BAS Application Software) occurs over the TCP connection to the server. All other clients must create a UDP socket using port 5211 to receive broadcast packets once they have an association with the server. Control actions are sent to the BAS network broadcast address and port 5211 over a UDP connection. Control actions sent by UI clients are sent to the MC over the TCP connection on the User's network, the MC then sends the control action message to the broadcast address of the BAS network.

The BAS protocol uses Element IDs to indicate the sending and destination Element. The Element ID is based on the device's MAC address.

As described earlier, the BAS server has a process that listens for broadcast packets for clients to learn the IP address of the server on the local area network (LAN). This feature eliminates the need to pre-configure clients with a server IP address. Server and clients may be on any LAN and find each other. This process uses Association Request and Association Reply messages.

Clients send an Association Request with its IP address in the payload. The client creates a UDP socket using the LAN's broadcast address and port 5211. The client sends the Association Request over this socket.

The server will create a UDP socket using the Client's IP address reported in the Application Data field and port 5212. The server then sends an Association Reply message with its IP address in the Application Data field.

Clients send an Association Request to the server to establish an association.

Clients provide their Product Type in the Association Request message. This allows the server to know what types of Elements are in the system. The server may use this information when processing messages from clients.

Upon receiving and Association Request message, the server will respond with an Association Reply message.

Clients learn the server's Element ID from the Association Reply packet. Clients then use the server's Element ID in packets sent to the server.

Clients may decide to establish an association with the responding server based on the server's response. Alternatively, clients may complete the association process with the responding server once the Association Reply message is received.

A client completes the association procedure by sending an Association Select message back to the server. The server will acknowledge the Association Select message with an acknowledgement message.

Servers and Clients may send application data once associated.

The BAS Communications Protocol includes a System ID which is a unique system identifier used to group system devices into a unique system. The System ID field may be used to keep devices from one system reacting to events from another system. In this way, two systems within radio range of each other will never interact as long as the two networks are separate. However, if the deployed network allows multiple network nodes from one system to receive messages from another system, then the use of the System ID will prevent nodes from reacting to an event from another system.

Control Events Communications

Client devices that associate to the BAS Network as nodes on the network and are able to send and receive control events are referred to as Elements. For example, an Audio Zone Player, as described above, is an Element of the BAS.

Preset configurations for each element may be saved and are referred to as Moods. Moods are defined in the BAS Communications Protocol as comprising; a mood ID unique within a system; a descriptive name for the mood; the ID of the room, or zone, the mood is associated with; the days of the week when the mood is to activate; the date and time when the mood is to activate; the number of elements controlled by the mood; the ID of the Control Action containing the parameters for setting the Element's state when the Mood is active; the Element ID of the second specific Element; the ID of the Control Action containing the parameters for setting the Element's state when the Mood is active; the Element ID of the nth specific Element; and the ID of the Control Action containing the parameters for setting the nth Element's state when the Mood is active.

Multiple Moods may be combined to form a preset configuration referred to as an Experience. Experiences are defined in the BAS Communications Protocol as comprising: an experience ID that identifies the Experience, and is unique within a system; a Descriptive name of the Experience; the days of the week the experience is to activate; the date and time the Experience is to activate; the number of included Moods; the Mood ID of the first included Mood; the number of seconds to delay activating Mood ID 1 when this experience is activated; the Mood ID of the second included Mood; the number of seconds to delay activating Mood ID 2 when this experience is activated; the Mood ID of the nth included Mood; and the number of seconds to delay activating Mood ID n when this experience is activated.

The Capture Mood feature performed by the BAS Application Software is described as follows. The UI, when displaying Room Elements, can get the current state of each Element by sending a Get Element State to each Element in the room. The UI can then update its display with the current status of the Elements. When the “Capture Mood” feature is selected by the user the UI must create new Control Action definitions for each element's desired state and send these to the MC. The MC will include the Control ID assigned to the new Element Control Action definition in the Acknowledgement so UI applications have the control ID for use in creating a Mood definition. The UI application then creates a new Mood definition that includes the Element IDs and the corresponding Element Control Action definition IDs, and sends the new Mood definition to the MC. The MC will then send Mood and Control Action messages to the applicable elements so they have the new data for processing Mood On and Experience On events.

Embodiments of the BAS comprise Elements with local control that may store locally the subset of system configuration items that pertain to the Element. Elements with local control include, but are not limited to, Lighting Controls, Audio zone players, and Thermostats. Elements store the system configuration that applies to the Element so that system operation does not depend on the MC application software once system configuration is complete. The benefit of this embodiment lies in there being no single point of failure in the system other than the IP network being available. In this embodiment, the BAS is one where system control is distributed and events are sent over the network during system operation, instead of sending the actual control parameters every time a control action is to be performed.

The BAS Application Software system setup process interacts with the MC to define all Element behavior, and Mood and Experience configuration. Elements retrieve their application configuration from the MC at startup. Any changes made by the User once an Element has retrieved its configuration at startup may be communicated to the applicable elements. The MC will send Elements new/updated configuration as it receives the updates from the User.

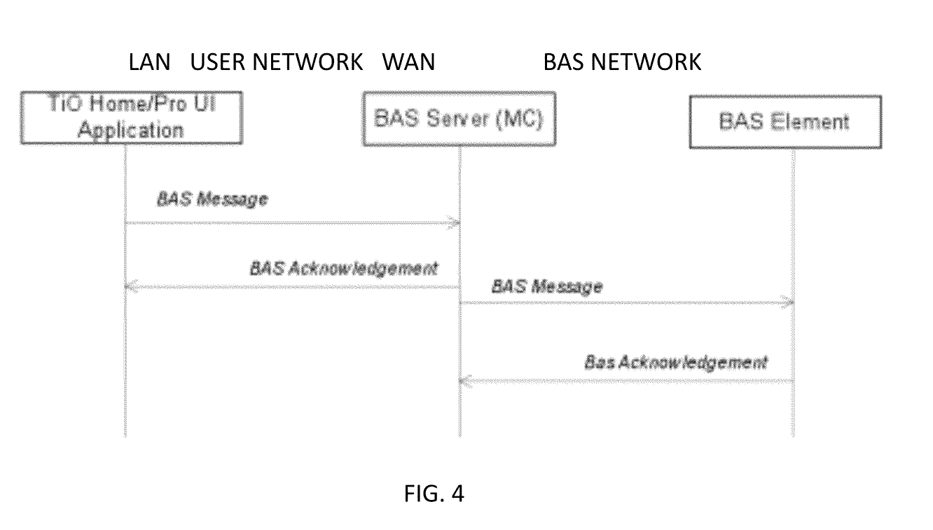

The primary user interface in a BAS is the BAS Application Software. The BAS system architecture has the UI applications communicating on the end user's network, and all other BAS clients attached to the BAS network/LAN. The MC software runs on an IP wireless access point with firewall, routing, and NAT functions, and is connected to the user's network via its WAN interface. The router's LAN is the BAS network used to communicate with all BAS system elements. FIG. 4 shows a diagram of an exemplary simplified depiction of the message exchange for UI applications on the MCs WAN communicating with BAS elements inside the BAS network.

As shown in FIG. 4, the BAS Software Application on the WAN sends all BAS messages to the MC, and it relays the BAS message to the BAS Element(s) on the BAS network. BAS Software Application messages for system configuration are sent to the MC. The system configuration messages generally affect the system database on the MC, and are not typically relayed on the BAS network (the MC will relay some messages for the cases where the BAS message applies to an element).

Element Control Action messages generated from the BAS Software Application are relayed by the MC to the specific BAS Client element on the BAS Network. BAS Software Application sets the Destination Address in the BAS Packet header to that of the specific BAS client element. The MC will then relay the control message to the indicated BAS client element.

Element control by BAS Software Application within the BAS Network is performed by sending Control Action messages via UDP to the LAN broadcast address and port 5211 (the BAS UDP port). The Destination Address in the BAS packet header is set to the element to be controlled, The Control ID in the application data is set to 0 to indicate the message is meant to cause immediate control, and that the Control Action message is not part of a mood or experience.

Control events are communicated by sending an event message on the network. These messages are sent using UPD to the network's broadcast address and a port. An example of the communications that occurs when a control action is performed on a system component with a User Interface follows.

Once a user chooses an option within the any of the UI interfaces, a UDP broadcast message is sent out on port 5211 and is received by all device members on BAS network. In the example in FIG. 2, a mood called “News & Relaxation” is selected from the UI which includes lighting and audio zone controls associated with it. The tablet computing device will then send a UDP broadcast indicating which mood was selected, and each member of BAS network that has a local control associated with the mood will react accordingly. For instance, the Lighting Control element behavior defined for the mood to ramp up lighting to 60%, and the Streaming Audio Player element behavior defined for the mood is to play corresponding news stream. The BAS protocol client in the Streaming Audio Player element then sends the appropriate API message corresponding to the specific mood control to the appropriate API to play back the news stream. The MC also records the UDP broadcast so that it can record the history of user-initiated actions.

Remote Access Server (RAS)

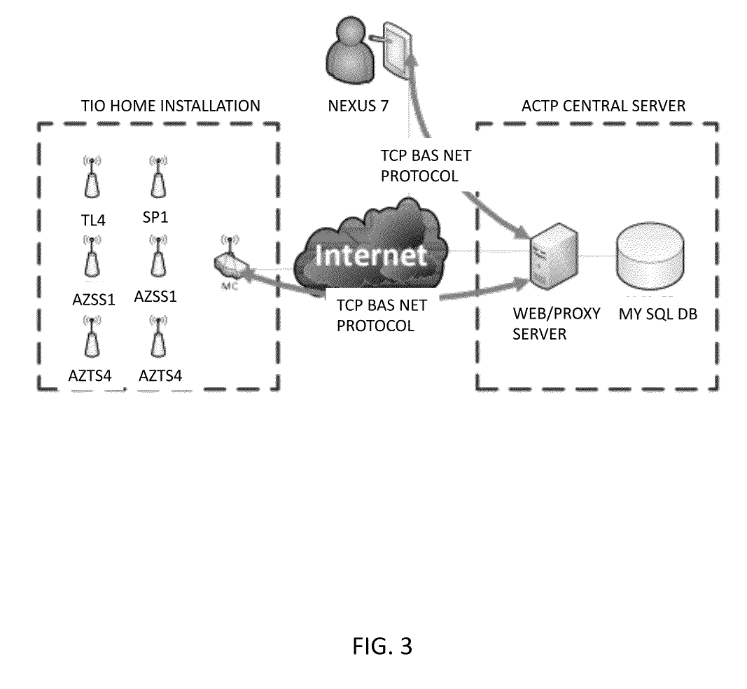

Users of the BAS may be able to access their system remotely via the Internet. Embodiments of the present invention will support this functionality by deploying a BAS Proxy on the Internet. A Block diagram of an exemplary representation of the communications between the remote user and their system is shown in FIG. 3.

As indicated in FIG. 3, the BAS Application Software will communicate with the user's BAS using the BAS proxy. BAS Application Software behavior differs from when it is connected to the local network in that it sends (and receives) all BAS messages using a connection to the proxy. An exemplary representation of an embodiment of the process follows.

First, the MC in the user's dwelling makes a secure TCP connection to the public IP address of the proxy server. Next, the user launches the BAS Application Software on a tablet computing device and chooses to connect to their home, opening a secure TCP connection from the tablet computing device to the proxy. The BAS Application Software prompts the user for a username and password for the proxy. Once entered, the BAS Application Software sends the username and password to the proxy, and the proxy authenticates the user by checking for the account in the server database. Upon success, the proxy now relays bidirectional BAS protocol data between the authenticated tablet computing device and the corresponding MC owned by the user.

Embodiments of the BAS Application Software need a means to determine if it connected locally to the MC or needs to connect to the proxy. It can make this determination using a Server Discovery process. When connected to the proxy, the BAS Application Software interaction with the MC via TCP is the same as when connected to the user's LAN in the dwelling. The BAS Application Software sends all BAS protocol packets to the proxy, and receives all BAS protocol messages from the proxy over the secure TCP connection to the proxy.

### HARDWARE EMBODIMENT

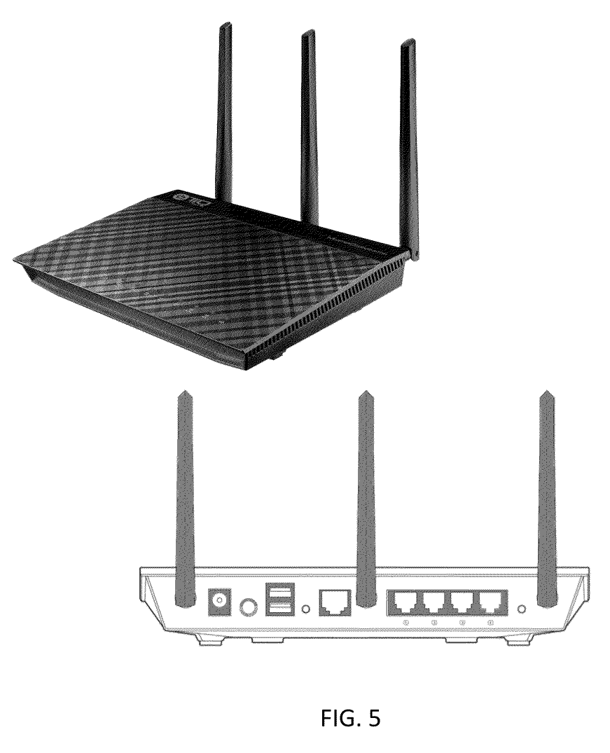

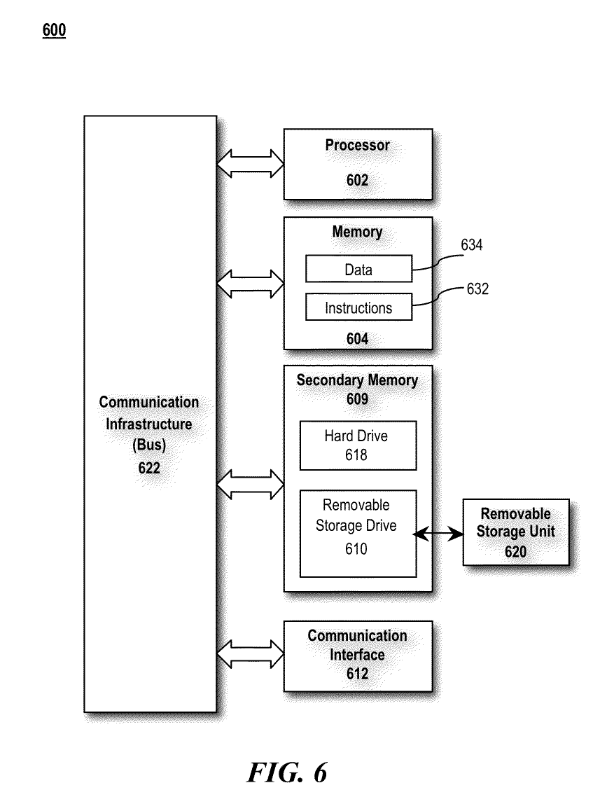

Referring now to FIG. 6, there is provided a simplified pictorial illustration of the hardware requirements for implementing some or all of the components of the Building Automation System, in which the present disclosure may be implemented. For purposes of this invention, computer system 600 may represent any type of computer, information processing system or other programmable electronic device, including a client computer, a server computer, a portable computer, an embedded controller, a personal digital assistant, a Cloud computing device, a tablet computing device, and so on. The computer system 600 may be a stand-alone device or networked into a larger system. Computer system 600, illustrated for exemplary purposes as a mobile computing device, is in communication with other networked computing devices (not shown). As will be appreciated by those of ordinary skill in the art, a network may be embodied using conventional networking technologies and may include one or more of the following: local area networks, wide area networks, intranets, public Internet and the like.

Throughout the description herein, an embodiment of the invention is illustrated with aspects of the invention embodied solely on computer system 600. As will be appreciated by those of ordinary skill in the art, aspects of the invention may be distributed amongst one or more computing devices which interact with computer system 600 via one or more data networks such as, for example, the Internet. However, for ease of understanding, aspects of the invention have been embodied in a single computing device—computer system 600.

Computer system 600 includes inter alia processing device 602 which communicates with an input/output subsystem 606, memory 604, and storage 610. The processor device 602 is operably coupled with a communication infrastructure 622 (e.g., a communications bus, cross-over bar, or network). The processor device 602 may be a general or special purpose microprocessor operating under control of computer program instructions 632 executed from memory 604 on program data 634. The processor 602 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own special purpose processor for executing instructions. Alternatively, some or all of the sub-processors may be implemented in an ASIC. RAM may be embodied in one or more memory chips.

The memory 604 may be partitioned or otherwise mapped to reflect the boundaries of the various memory subcomponents. Memory 604 may include both volatile and persistent memory for the storage of: operational instructions 632 for execution by CPU 602, data registers, application storage and the like. Memory 604 can include a combination of random access memory (RAM), read only memory (ROM) and persistent memory such as that provided by a hard disk drive 618 in secondary memory 609. The computer instructions/applications that are stored in memory 604 are executed by processor 602. The computer instructions/applications 632 and program data 634 can also be stored in hard disk drive 618 for execution by processor device 602.

The computer system 600 may also include a removable storage drive 610, representing a floppy disk drive, a magnetic tape drive, an optical disk drive, and the like. The removable storage drive 610 reads from and/or writes to a removable storage unit 620 in a manner well known to those having ordinary skill in the art. Removable storage unit 620, represents a floppy disk, a compact disc, magnetic tape, optical disk, CD-ROM, DVD-ROM, etc. which is read by and written to by removable storage drive 610. As will be appreciated, the removable storage unit 620 includes a non-transitory computer readable medium having stored therein computer software and/or data.

The computer system 600 may also include a communications interface 612. Communications interface 612 allows software and data to be transferred between the computer system and external devices. Examples of communications interface 612 may include a modem, a network interface (such as an Ethernet card), a communications port, a PCMCIA slot and card, etc. Software and data transferred via communications interface 612 are in the form of signals which may be, for example, electronic, electromagnetic, optical, or other signals capable of being received by communications interface 612.

In this document, the terms “computer program medium,” “computer usable medium,” and “computer readable medium” are used to generally refer to both transitory and non-transitory media such as main memory 604, removable storage drive 620, a hard disk installed in hard disk drive 618. These computer program products are means for providing software to the computer system 610. The computer readable medium 620 allows the computer system 600 to read data, instructions, messages or message packets, and other computer readable information from the computer readable medium 620.

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

In the Summary of the Invention above and in the accompanying supporting disclosures, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

In light of the foregoing description and accompanying disclosures, it should be recognized that embodiments in accordance with the present invention can be realized in numerous configurations contemplated to be within the scope and spirit of the invention. Additionally, the description above is intended by way of example only and is not intended to limit the present invention in any way, except as set forth in the claims recited herein.

What is claimed is:

1. A Building Automation System comprising:
a data network;
a communications protocol;
a central node that stores a one or more configuration and control information;
a one or more individual nodes that perform a one or more control functions; and
a one or more nodes with a user interface for accessing and using the configuration and control information;
wherein all said nodes are operably connected via the data network and interact according to the communications protocol.

2. The Building Automation System of claim 1 where said data network is an Internet Protocol network with said nodes connected with wired and wireless interfaces.

3. The Building Automation System of claim 1 where said central node is a Server on the data network comprising a database representing a system configuration and control information, where the system configuration and control information comprises an inventory of the system devices for appliance control, a one or more control profiles for all system control devices, and a one or more control profiles that combine two or more control profiles.

4. The Building Automation System of claim 1 where said one or more individual nodes are a one or more Clients comprising a one or more control device on said data network wherein each said control device further comprises a user interface for using the system configuration and control information.

5. The Building Automation System of claim 1 where said communications protocol allows the Server and Clients to interact.

6. The Building Automation System of claim 1 where said one or more nodes with a user interface comprises a user device that has been specially programmed to execute instructions from an application that provides a user interface for configuration and control of the BAS over the data network.

7. A system for building automation, the system comprising:
a user network;
a Master Coordinator operably connected to said user network;
a BAS Network created by the Master Coordinator, operably connected to the Master Coordinator, but separate from said user network;
a one or more Elements operably connected to the BAS Network;
a one or more user computing device operably connected to the user network; and
a BAS Software Application running on said user computing device.
